(19) United States
(12) Patent Application Publication
(10) Pub. No.: US 2026/0084802 A1
(43) Pub. Date: Mar. 26, 2026

(54) FOLDING WING MECHANISM

(71) Applicant: Airbus Operations Limited, FILTON (GB)

(72) Inventors: Paul MORRELL, FILTON, BRISTOL (GB); Cameron James RUSSELL, FILTON (GB); Matthew HAND, FILTON (GB); Richard HIPKISS, FILTON (GB)

(21) Appl. No.: 19/303,696

(22) Filed: Aug. 19, 2025

(30) Foreign Application Priority Data
Sep. 26, 2024 (GB) 2414130.1

(51) Int. Cl. B64C 3/56

(52) U.S. Cl. CPC B64C 3/56

(57) ABSTRACT

An aircraft wing tip that is movable by an actuator between a flight configuration, and a ground configuration which has a shorter wingspan for use in ground-based operations. Lugs that connect to arms of the actuator are integrally formed as part of the primary structure of either the fixed wing or outboard wing section, such as a folding tip section.

### CROSS-REFERENCES TO RELATED APPLICATIONS

This application claims the benefit of Great Britain Patent Application Number 2414130.1 filed on Sep. 26, 2024, the entire disclosure of which is incorporated herein by way of reference.

### FIELD OF THE INVENTION

The present invention concerns wing folding mechanisms. More particularly, but not exclusively, this invention concerns an aircraft wing comprising a rotatable outboard wing section, and a method of operating a folding wingtip.

### BACKGROUND OF THE INVENTION

It is increasingly desirable to have larger wing spans across all sizes of passenger aircraft as a means to improve fuel efficiency. Particularly for larger aircraft, however, the maximum aircraft span is effectively limited by airport operating rules which govern various clearances required when maneuvering around the airport (such as the span and/or ground clearance required for gate entry and safe taxiway usage).

Therefore, folding wing tip devices have been introduced into passenger aircraft, where a wing tip device is movable between a flight configuration for use during flight, and a ground configuration for use during ground-based operations. In the ground configuration, the wing tip device is moved away from the flight configuration such that the span of the aircraft wing is reduced, thereby allowing use of existing gates and safe taxiway usage.

There is limited space in the wing, particularly near the tip, for equipment that needs to be housed within the wing. There are therefore various challenges in installing actuation systems for folding wing tip devices. For example, commercially available actuators require brackets, linkages and the like in order to provide the interface between the actuator and the structure being moved. Making the required space available for such equipment is difficult as a result of the strict space restrictions that exist within the wing. There is also a trend towards designing and manufacturing aircraft wings with higher aspect ratios—i.e., both long and narrow wings, which further constrains space in or near the tip of the wing.

The present invention seeks to mitigate one or more of the above-mentioned problems. Alternatively or additionally, the present invention seeks to provide an improved wing folding mechanism.

### SUMMARY OF THE INVENTION

The present invention provides, according to a first aspect, an aircraft wing comprising a fixed wing and an outboard wing section at the tip thereof, wherein the fixed wing comprises primary structure and the outboard wing section comprises primary structure. The aircraft wing is configurable between: (i) a flight configuration for use during flight and (ii) a ground configuration for use during ground-based operations. In the ground configuration the outboard wing section is rotated away from the flight configuration about the hinge axis of a hinge arrangement such that the span of the aircraft wing is reduced. The aircraft wing further comprises at least one lug integrally formed as part of one of the primary structure of the fixed wing and the primary structure of the outboard wing section. There is also an actuator which is configured to directly act on the integrally formed lug to move the wing between the flight configuration and the ground configuration.

The lug (or lugs) and the corresponding primary structure(s) may thus be made as one piece, for example as a monolithic structure. The primary structure and the integrated lug(s) are so configured that the lug(s) can withstand the loads experienced during the actuation of the outboard wing section. The provision of an integrally formed lug renders the provision of further intermediate fittings and brackets (as traditionally used to attach actuator components to primary structure) unnecessary. This may reduce the weight and complexity of the system, reduce the part count, and reduce the space required to mount the actuator, as explained in further detail below. The provision of an integrally formed lug may also enable a better overall solution in terms of maintenance and lifetime operation considerations, given that alternative solutions, using brackets and bolts and/or other intermediate fittings that join primary structure to other parts of the wing, may have differing levels of performance/expected operational lifespan, as compared to primary structure.

The size of the actuator, when compared with the depth of the wing and space available at the hinge axis, is relatively large. As such, one consideration for folding wings may be minimizing the space required to mount the actuator. By forming the lug as part of the primary structure of the wing, the need for bulky connections is removed, reducing the space required the mount the actuator.

It may be that the outboard section of the wing is configured to be extended out to a position in which the wing is in the flight configuration, and is configured to be retracted to a position in which the wing is in the ground configuration and the total length of the wing is reduced. In the flight configuration the trailing edge of the outboard wing section may be a continuation of the trailing edge of the fixed wing. The leading edge of the outboard wing section may be a continuation of the leading edge of the fixed wing, such that there is a smooth transition from the fixed wing to the outboard wing section. It will be appreciated that there may be a smooth transition, even where there are changes in sweep or twist at the fixed wing/outboard wing section. However, there are preferably no discontinuities at the junction between the fixed wing and outboard wing section.

The outboard wing section may be a wing tip extension, for example a generally planar tip extension. In other embodiments, the outboard wing section may comprise, or consist of, a non-planar device, such as a winglet. The outboard wing section may include, for example, trailing edge moveable devices for control (ailerons) or leading edge devices for stall protection, such as slats or droop nose devices.

The actuator may be a rotary actuator. The actuator may be a geared rotary actuator.

The actuator may be positioned between the fixed wing and outboard wing section. For example the actuator may be positioned at or directly adjacent to the interface between the fixed wing and outboard wing section. The actuator may be positioned at or within the hinge arrangement of the aircraft wing.

It may be that the wing is so configured that the movement of the outboard wing section between its ground configuration and its flight configuration is limited to a simple rotation about the hinge axis.

The actuator may be positioned such that the axis of rotation of the actuator is parallel to the hinge axis of the hinge arrangement.

The actuator may be positioned such that the axis of rotation of the actuator is concentric to the hinge axis of the hinge arrangement. This is allowed by virtue of the actuator being positioned at or within the hinge arrangement. Sympathetic loading of the actuator may be improved as a result of such a concentric arrangement.

The concentricity of the axis of rotation of the actuator and the hinge axis may advantageously facilitate a solution in which no clevis, strut, or intermediate bracket is required to attach the actuator to the integrally formed lugs. This reduces the structures required to cause rotation of the outboard wing section using the actuator, thereby reducing the space required for the folding wing.

The actuator may be a multi-slice actuator. A multi-slice actuator may be described as an actuator with a plurality of slices which share a common axis of rotation. Each slice may include an output arm configured to rotate about the shared axis. It may be that each slice shares a substantially equal load.

Multi-slice actuators add an extra layer of protection against actuator failure, as if one or more slices fail or are damaged, the load for that slice may be redistributed and shared amongst the remaining functioning slices.

The arm of the actuator may be integrally formed as part of the output of the actuator. By doing this, the actuator and its associated arm does not need to be associated with or connected to any clevis, strut, or intermediate bracket between the actuator and the integrally formed lugs.

The hinge arrangement may form part of primary structure of the fixed wing. The hinge arrangement may form part of primary structure of the outboard wing section. A first portion of the hinge arrangement may protrude from the tip of the fixed wing and may be configured to interlace with the corresponding second portion of the hinge arrangement, which may protrude from the innermost part of the outboard wing section (closest to the fuselage). It will be understood therefore that the hinge arrangement may consist of, or may comprise, a hinge formed by a portion (e.g. the first portion mentioned above) of primary structure that forms part of the fixed wing and a portion (e.g. the second portion mentioned above) of primary structure that forms part of the outboard wing section, the two portions being connected, optionally with the use of one or more pins, for relative rotation about the hinge axis.

It may be that the hinge arrangement comprises one or more pins which have longitudinal axes parallel to the hinge axis. The one or more pins may be arranged to directly link the primary structure of the fixed wing and the primary structure of the outboard wing section to facilitate rotational movement of the outboard wing section about the hinge axis.

The hinge arrangement may comprise a piano hinge arrangement. The hinge arrangement may comprise a series of holes and associated pin(s) (e.g., received in the holes to facilitate rotation about the axis defined by the pin(s)) along the hinge axis which connect the two portions together.

The hinge arrangement may be a locking hinge arrangement. The locking hinge arrangement may comprise a locking mechanism arranged to lock the relative rotation of the fixed wing and outboard wing section, for example to lock the aircraft wing in its flight configuration. The same locking mechanism or a different locking mechanism may be provided to lock the relative rotation of the fixed wing and outboard wing section in a different position, for example in the ground configuration.

Various different mechanisms may be suitable for locking the rotation of the outboard wing section, as would be understood by a skilled person. For example, the locking hinge arrangement may comprise another set of integrally formed protrusions of the primary structures, which may comprise a series of holes that are not positioned on the hinge line. Pins (e.g. locking pins) may be moved in and out of these holes in the hinge arrangement, such that the relative rotation of the outboard wing section and fixed wing can either be prevented or allowed. To prevent the relative rotation of the two structures in the flight configuration, the pins may be slid into the holes of the hinge arrangement, such that the two parts of the hinge are prevented from moving about the hinge axis. To allow the relative rotation of the two structures, the pins may be removed from the holes of the hinge arrangement. There may be one or more locking pins, which are arranged to facilitate selective locking (and unlocking) of the hinge arrangement, thus selectively preventing (and permitting) rotational movement of the outboard wing section about the hinge axis.

The locking pins in the locking hinge arrangement may have longitudinal axes parallel to the hinge axis.

The locking mechanism of the hinge arrangement may be configured such that the actuator is protected from the flight loads experienced by the wing. The locking mechanism of the hinge arrangement is preferably separate from the actuator and/or positioned externally of the actuator. The locking pins of the locking mechanism may ensure that the majority of the flight loads are sustained by the primary structure of the fixed wing, the primary structure of the outboard wing section, and the pins themselves (e.g., the locking pins and/or any pins provided to allow rotation about the hinge axis). The locking pins may for example be separate from, and positioned externally of, the actuator.

The actuator may be configured to be disengaged when the aircraft wing is locked in a flight configuration.

When the wing is in the ground configuration (e.g. with the outboard wing section retracted), the aircraft incorporating the wing, may be unsuitable for flight. For example, the outboard wing section may be aerodynamically and/or structurally unsuitable for flight in the ground configuration. The aircraft is preferably configured such that, during flight, the outboard wing section is not moveable to the ground configuration (e.g., actively prevented from so moving to the ground configuration), for example by use of a locking system, preferably such as the above-described locking hinge arrangement and/or locking mechanism. The aircraft may comprise a sensor for sensing when the aircraft is in flight. When the sensor senses that the aircraft is in flight, a control system is preferably arranged to disable the possibility of moving the outboard wing section to the ground configuration, for example by preventing unlocking of the outboard wing section locked in the flight configuration.

The flight loads being mostly transmitted by the primary structures of the wing shields the actuator from loads that could cause it damage. This means that the likelihood of damage to the equipment is reduced, and the strength requirements of the actuator is lowered. Due to the strict space limitations within a folding wing, reducing the strength requirements of the actuator may allow for a smaller actuator to be used.

The actuator may only need the strength required to actuate the outboard wing section when on the ground. As such, the lug(s) (for enabling the actuator to move the outboard wing section) may also only require the structural strength to sustain loads imparted by the actuator when on the ground and moving between the two configurations.

The hinge axis may extend in a line of flight direction.

A surface of the lug may be in direct contact with a surface of the actuator. One or more lugs may each attach directly to an arm of the actuator, for example by being directly bolted together. The lug may be attached to the arm of the actuator without the use of an intermediate structure like a clevis, strut, or intermediate bracket. This is enabled by the concentricity (or near concentricity) between the axis of rotation of the actuator and the hinge axis.

A lug may comprise a series of holes which correspond to a similar set of holes in the arm of the actuator. The holes of said lug may include a bushing for receiving a fixing for example a pin (e.g. one or more fixing pins), bolt or the like.

Each bushing may be in the form of a double eccentric bush, so that in use, a small amount of movement can be tolerated in the connection. The two structures may be connected together by means of the (fixing) pins rigged with the double eccentric bushes. In the case of a hinge axis and axis of rotation of the actuator not being perfectly concentric, double eccentric bushes may compensate for the relative movement of the outboard wing section and the output (e.g. moving arm(s)) of the actuator, given that the hinge axis and axis of rotation of the actuator are parallel and sufficiently close to a concentric arrangement. If the wing is designed to have the hinge axis concentric to the axis of rotation of the actuator, the use of double eccentric bushes, can assist in reducing the risk of damage, or system misfunction, as a result of misalignment of the two axes, that may be caused due to relative movement of parts during use and/or manufacturing tolerances.

Alternatively, or additionally, double eccentric bushes may allow for wings to be designed with the hinge axis eccentric to the axis of rotation of the actuator (a non-concentric arrangement). The flexibility to design an aircraft wing with the hinge axis eccentric to the axis of rotation of the actuator means that the actuator can be positioned slightly differently depending on the requirements of the design and the limited space available.

The hinge arrangement may comprise at least one further lug integrally formed as part of the primary structure of the fixed wing and at least one further lug integrally formed as part the primary structure of the outboard wing section. Such lugs may each comprise a hole for the passage of a hinge pin, to facilitate rotation of the hinge arrangement about the hinge axis. The holes of such lugs may include a bushing for receiving a hinge pin.

It may be that the hinge arrangement comprises multiple lugs integrated with primary structure of one of the fixed wing and an outboard wing section and that the lug moved by the actuator is positioned between them, for example midway between the lugs that are furthest apart.

The aircraft wing may comprise at least two integrally formed lugs, each of which are integrally formed as part of either the fixed wing or outboard wing section.

Lugs may be used to connect all of the actuator arms to the relevant primary structures of the fixed wing and the outboard wing section. In multi-slice actuators, a lug may be used to connect the arms of each slice to the primary structures of the aircraft wing.

At least one arm of the actuator may be attached to two separate integrally formed lugs, positioned on opposing faces of the arm of actuator. Lugs may be used to ‘sandwich’ an arm of the actuator, such that the arm of the actuator is connected to two lugs, one on each side of the arm.

By having each arm of the actuator attach to two separate lugs may further reduce the strength requirements of the lugs and may provide some level of contingency in case of failure in one of the lugs.

It may be that the lug on which the actuator directly acts to move the wing between the flight configuration and the ground configuration also forms at least part of the hinge. It may be that the lug on which the actuator directly acts to move the wing between the flight configuration and the ground configuration is separate from the hinge.

The aforementioned lugs may have substantially the same shape. The main body of a lug may have parallel spaced apart planar surfaces that have normal axes that are parallel to the hinge axis. The thickness of the lug between the parallel spaced apart planar surfaces may be between 10 mm and 90 mm, optionally greater than 20 mm and optionally less than 75 mm.

The actuator output may be in the form of an arm having parallel spaced apart planar surfaces that have normal axes that are parallel to the hinge axis. The thickness of the arm between the parallel spaced apart planar surfaces may be between 5 mm and 75 mm, optionally greater than 10 mm and optionally less than 60 mm.

The aircraft wing may be configured to be positioned relative to the fuselage of an aircraft.

With the push for higher and higher aspect ratio wings, the embodiments of the invention are well suited to use in such wings (i.e. long narrow wings), which typically have confined space in which to mount equipment. The aspect ratio of a wing is defined as the ratio of its span to its mean chord and equal to the square of the span divided by the wing area.

The hinge axis of the aircraft wing may be more than 12.5 m away from the fuselage, preferably more than 15 m away, and optionally more than 17 m away.

The maximum depth of the wing (height between upper and lower wing covers) at the hinge axis may be less than 50 cm, and in some embodiments may be less than 35 cm. The depth of the wing at the hinge axis may be less than 32.5 cm, preferably less than 27.5 cm, and optionally less than 22.5 cm.

The length of the outboard wing section of the aircraft wing may be more than 3 m, preferably more than 4 m, and more preferably more than 5 m.

The span ratio of the fixed wing relative to the outboard wing section may be such that the fixed wing comprises at least 60%, 70%, 80%, 90%, or more, of the overall span of the wing. The span ratio of the fixed wing relative to the outboard wing section may be such that the outboard wing section comprises at least 10%, 20%, 30%, 40%, or more, of the overall span of the wing.

In the flight configuration, the span may exceed an airport compatibility limit. In the ground configuration the span may be reduced such that the span (with the wing in the ground configuration) is less than, or substantially equal to, the airport compatibility limit. The airport compatibility limit is a span limit (for example relating to clearance restrictions for buildings, signs, other aircraft). The compatibility limit is preferably a gate limit.

It may be that the span of the aircraft wing in the ground configuration is less than a wing span limit and that the span of the aircraft wing in the flight configuration is greater than the wing span limit. The wing span limit may be 36 m. The wing span limit may be 52 m. The wing span limit may be 65 m. The wing span limit may be 80 m. It may be that the span of the aircraft wing is at least 4 meters shorter (possibly 5 meters or more shorter) in the ground configuration than in the flight configuration.

It may be that the outboard wing section undergoes a rotation of more than 45 degrees, preferably more than 60 degrees, and optionally more than 75 degrees as it moves from the ground configuration to the flight configuration. A higher amount of rotation may enable a greater difference in wing span as between the ground configuration and the flight configuration.

The mean chord of the wing may be less than 6.5 m, less than 5 m, and more preferably less than 4.5 m. The chord of the wing at the interface between the fixed wing and the outboard wing section may be less than 5 m. For example, for an aircraft having a wing span in the ground configuration of between 65 m and 80 m, the chord of the wing at the interface between the fixed wing and the outboard wing section may be greater than 3 m but less than 5 m. For an aircraft having a wing span in the ground configuration of 65 m or less, the chord of the wing at the interface between the fixed wing and the outboard wing section may be less than 4 m, and may optionally be less than 3 m.

The aspect ratio of the wing may be greater than 8, possibly greater than 9, and optionally 10 or higher. In some embodiments it may be that the aspect ratio of the wing is 11 or 12 or more.

According to a second aspect of the invention there is also provided a method of operating a folding wingtip. The folding wingtip may for example be the outboard wing section described in relation to the first aspect of the invention. The method comprises directly driving, using an actuator, the rotation, relative to the rest of the wing, of the folding wingtip via a lug integrally formed as part of one of the primary structures of the wing. The method may also comprise locking the folding wingtip in a flight configuration such that, in flight, loads are primarily transferred from the wingtip into the rest of the wing by the primary structure of the wing. For example, this may be achieved by locking a hinge arrangement of the folding wingtip in a flight configuration, preventing the rotation of the folding wingtip relative to the rest of the wing. The method may also comprise unlocking the folding wing, such that the actuator can rotate the folding wingtip. As a result of the flight loads being primarily transferred from the wingtip into the rest of the wing by the primary structure of the wing, the actuator can be shielded from (e.g., substantially isolated from) in-flight loads. It will of course be appreciated that, in use, some loads (e.g., comparatively trivial or minor loads) acting between the wingtip and the rest of the wing may be carried by parts of the wing not being primary structure of the wing. The primary structure of the wing may be configured to be able to transfer substantially all of the in-flight loads from the wingtip into the rest of the wing. It may therefore be that any loads sustained by the actuator during flight are negligible compared to the loads it withstands when operational and moving the folding wingtip between the flight configuration and the ground configuration.

The step of locking of the folding wingtip may be performed such that the wing remains in the flight configuration for the entire flight. The unlocking of the folding wingtip may be performed only when the aircraft is on the ground. The actuator may be used to directly drive the rotation of the folding wingtip (e.g., after the unlocking of the folding wingtip) to a ground configuration, having a reduced wing span.

According to a third aspect of the invention there is also provided an aircraft including the aircraft wing of the first aspect of the invention, and/or configured to perform the method of the second aspect of the invention.

The aircraft may be a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and optionally more than 75 passengers. The aircraft may be a commercial aircraft, for example a commercial passenger aircraft, for example a single aisle or twin aisle aircraft. The aircraft need not be configured for carrying passengers, but could for example be an aircraft of an equivalent size configured for cargo and/or used on a non-commercial basis. The aircraft may have a maximum take-off weight (MTOW) of at least 20 tonnes, optionally at least 40 tonnes, and possibly 50 tonnes or more. The aircraft may have an operating empty weight of at least 20 tonnes, optionally at least 30 tonnes, and possibly about 40 tonnes or more.

According to a fourth aspect of the invention there is yet further provided an aircraft wing comprising a folding wing tip configured for folding movement about a hinge axis, wherein the hinge axis is defined by a hinge having a first portion integrally formed with primary structure of an inboard part of the wing and a second portion integrally formed with primary structure of an outboard wing tip. The first and second portions of the hinge are mounted for rotation relative to each other, for example by means of a pin that passes through one or more holes of each of the first portion and of the second portion. One of the first and second portions of the hinge comprises a first integrally formed mounting fixture (e.g., a lug or protrusion or the like) and the other of the first and second portions comprising a second integrally formed mounting fixture (e.g., a lug or protrusion or the like). The aircraft wing comprises an actuator for moving the folding wing tip about the hinge axis. The actuator has a first part (which may be in the form of an arm and/or formed in part by actuator casing) that is directly attached to the first integrally formed mounting fixture. The actuator has a rotating output formed by actuator structure (e.g., a second part of the actuator, for example an actuator arm) that is directly attached to the second integrally formed mounting fixture.

There is also provided a kit of parts as set forth in claim 19.

It will of course be appreciated that features described in relation to one aspect of the present invention may be incorporated into other aspects of the present invention. For example, the method of the invention may incorporate any of the features described with reference to the apparatus of the invention and vice versa.

### BRIEF DESCRIPTION OF THE DRAWINGS

Embodiments of the present invention will now be described by way of example only with reference to the accompanying schematic drawings of which:

FIG. 1 shows an aircraft wing comprising a fixed wing and an outboard wing section according to an embodiment of the invention;

FIG. 2 shows an aircraft comprising an aircraft wing as shown in FIG. 1;

FIG. 3 shows an enlarged portion of an aircraft wing according to an embodiment of the invention in a flight configuration;

FIG. 4 shows the portion of the aircraft wing shown in FIG. 3 without the actuator;

FIG. 5 shows the portion of the aircraft wing shown in FIG. 3 in a ground configuration;

FIG. 6 shows the portion of the aircraft wing shown in FIG. 5 from another view; and

FIG. 7 is a flow diagram illustrating a method according to a further embodiment of the invention.

### DETAILED DESCRIPTION OF THE PREFERRED EMBODIMENTS

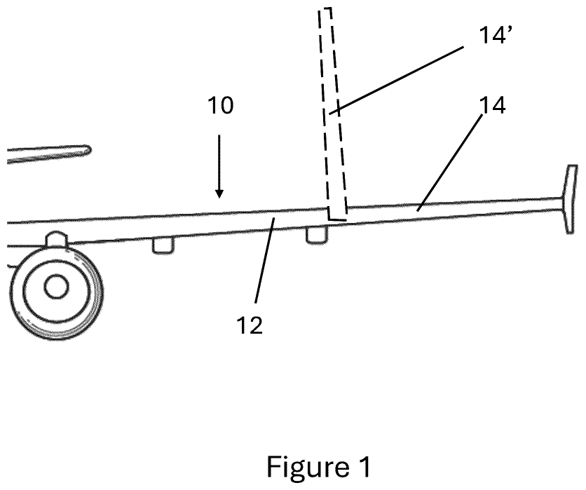

FIG. 1 shows an aircraft wing 10 comprising a fixed wing 12 and an outboard wing section 14, which forms a folding wing tip section. FIG. 1 is a composite image and shows the aircraft wing 10 both in a ground configuration (shown in broken line) and in a flight configuration (shown in solid line). It will be seen in the ground configuration the outboard wing section 14′ is folded up to be vertical (or near vertical) so that the span of the aircraft wing 10 is reduced compared to the flight configuration. A longer wing may provide the aircraft with an increased lift, better fuel efficiency, reduce the drag, and provide more stability in flight. However, there are size limitations imposed on current airport gates (gate limits), which restrict the wingspan of an aircraft to a certain length. Gate limits may be categorized by reference to an Aerodrome Reference Code letter according to the classification given by ICAO (the International Civil Aviation Organization). Example gate limits are code C (total wing span must be less than 36 m), code D (total wing span must be less than 52 m), code E (total wing span must be less than 65 m), and code F (total wing span must be less than 80 m). To overcome this, folding wings may be used, to improve the aspect ratio of the wings during flight, whilst not surpassing the gate limits. In this embodiment, the aircraft has a wing span of about 45 m in the flight configuration but with a wing span of just under 36 m in the ground configuration (making the aircraft suitable for use in airports having code C compatible gates (which set a limit on maximum wing span of 36 m). The outboard wing section 14 is about 5 m long to achieve this benefit. The chord of the wing at the interface between the fixed wing 12 and the outboard wing section 14 is about 1.9 m and the mean aerodynamic chord (MAC) of the wing is about 4.2 m. The maximum depth of the wing (height between upper and lower wing covers) at the junction between the outboard wing section and the folding wing tip section is about 20 cm. The aspect ratio of the wing is about 14.

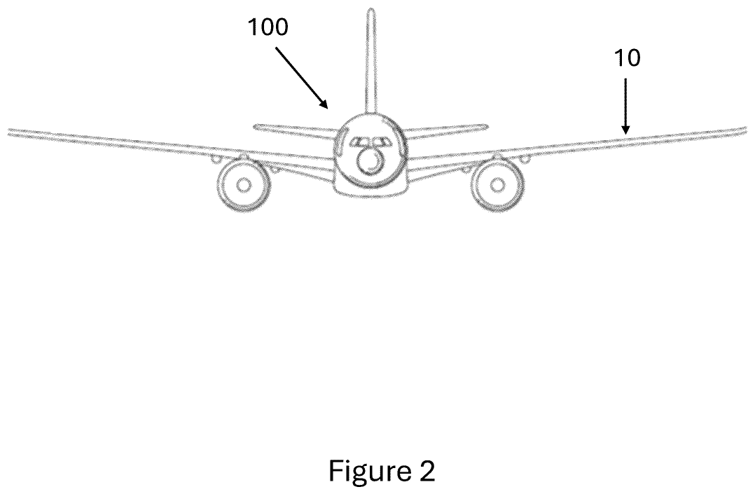

FIG. 2 shows the aircraft wing 10 of FIG. 1 as part of an aircraft 100. In FIG. 2 the aircraft wing 10 is in a flight configuration, where the outboard wing section 14 has been extended from the ground configuration shown in FIG. 1 (i.e., rotated to a position in which the outboard wing section 14 forms a continuation of the aerodynamic exterior surface profile of the fixed wing 12. Thus, as shown in FIG. 2, the aircraft wing 10 in the flight configuration forms one continuous shape, the outboard wing section 14 extending the general shape of the fixed wing 12.

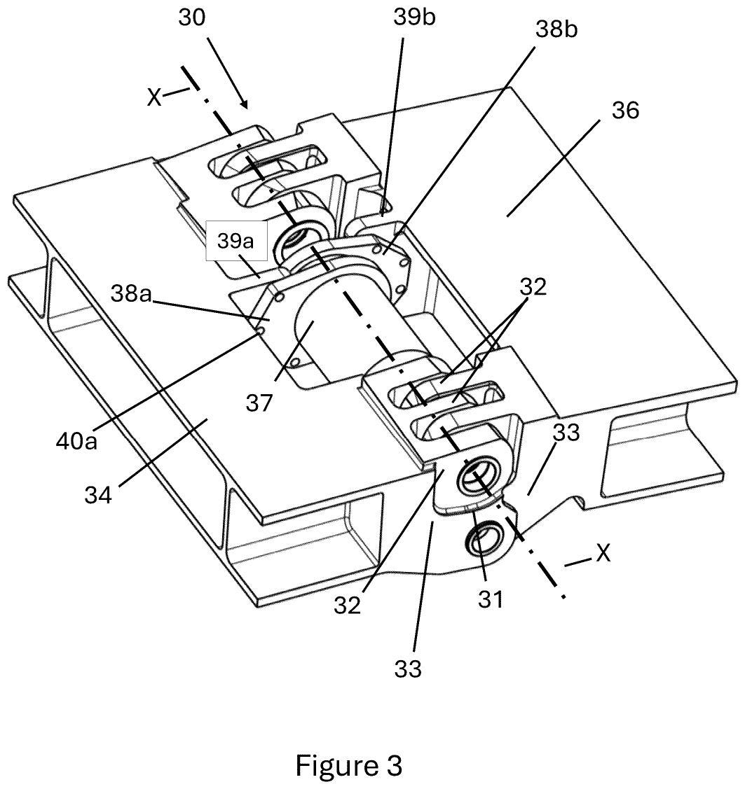

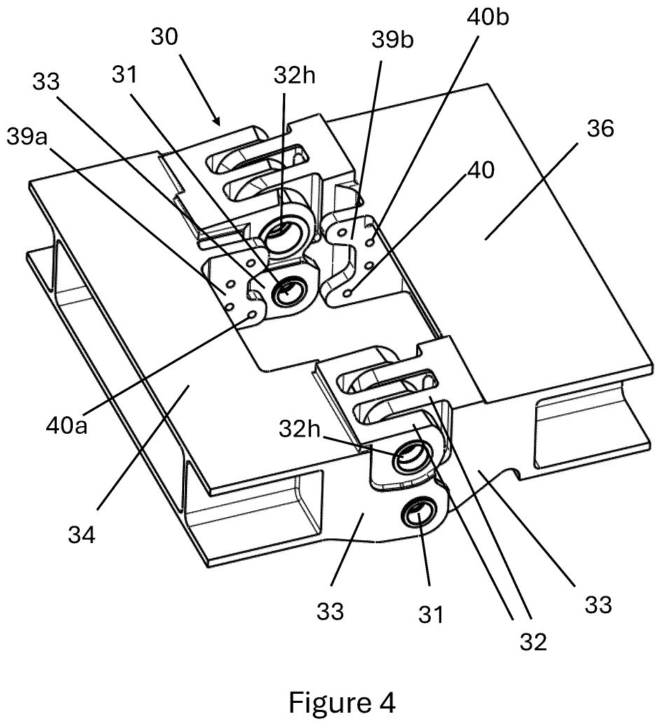

FIGS. 3 and 4 show an enlarged (cutaway) portion of the aircraft wing 10 where the fixed wing 12 and outboard wing section 14 connect, whilst the aircraft wing 10 is in a flight configuration. The fixed wing 12 and the outboard wing section 14 are connected via a hinge 30. The hinge 30 allows the folding, along a hinge axis (X-X), of the outboard wing section 14 between the flight configuration shown in FIG. 2, and the ground configuration, shown in FIG. 1. The hinge axis X-X is substantially parallel to the line of flight and/or the longitudinal axis of the fuselage of the aircraft.

The hinge 30 shown in FIG. 3 is in the general form of a piano hinge comprising interlacing protrusions 32 being lugs that are integrally formed with the primary structure of the fixed wing 34 and lugs that are integrally formed with the primary structure of the outboard wing section 36.

The protrusions 32 of the fixed wing 34 are connected to the protrusions 32 of the outboard wing section 36 for rotation relative to one another via hinge pins (not shown) that pass through the holes 32h formed in the protrusions 32. The holes 32h are bushed to provide a suitable seating for the pins and thus provide a suitable means for enabling maintenance and repair of the hinge without compromising primary structure. Other hinge arrangements may be suitable, however.

The folding of the aircraft wing 10 between the flight configuration and ground configuration is controlled by an actuator 37 (in this embodiment a geared rotary actuator) mounted in the vicinity of the hinge 30 (shown in FIG. 3, and omitted from FIG. 4). FIG. 4 shows the same portion of the aircraft 100 as FIG. 3 but with the actuator omitted and shows integrally formed lugs 39, 39a, 39b with holes 40 for facilitating connection of the actuator 37. The actuator 37 has an arm 38a rigidly connected or integrally formed with the actuator casing (or housing) that is directly bolted to the primary structure of the fixed wing 34 via fixing holes 40a (shown in FIG. 4) formed in one of the integrally formed lugs 39a. The actuator 37 has a single rotating actuator arm 38b which is directly bolted via holes 40b to an opposing lug 39b integrally formed as part of the primary structure of the outboard wing section 36. Fixing holes 40a, 40b are lined with double eccentric bushes (not shown) in order to accommodate any misalignment during operation, and/or from manufacturing, of the hinge axis with the axis of rotation of the actuator.

It will be understood that “primary structure” in an aircraft is structure which carries flight, ground, or pressurization loads, and is critical to the operation of the aircraft, and can thus be contrasted with secondary structure and tertiary structure. For example, failure of secondary structure would affect the operation of the aircraft but would not inevitably lead to its loss and failure of structure which is classified as tertiary structure would not significantly affect operation of the aircraft. In this embodiment the primary structure that forms the fixed wing 34 is a metal alloy material and the primary structure that forms the primary structure of the outboard wing section 36 is also a metal alloy material. In other embodiments, composite material may be used.

It will be understood that a lug may generally be described as a protrusion integrated with and extending from a structure or component, providing a designated point for attachment of something else for example equipment (e.g., an actuator arm, as in this embodiment) or corresponding lugs enabling relative rotation of one lug and associated structure.

The actuator 37 is a rotary actuator with the actuator's axis of rotation concentric to the axis (X-X) of the hinge 30.

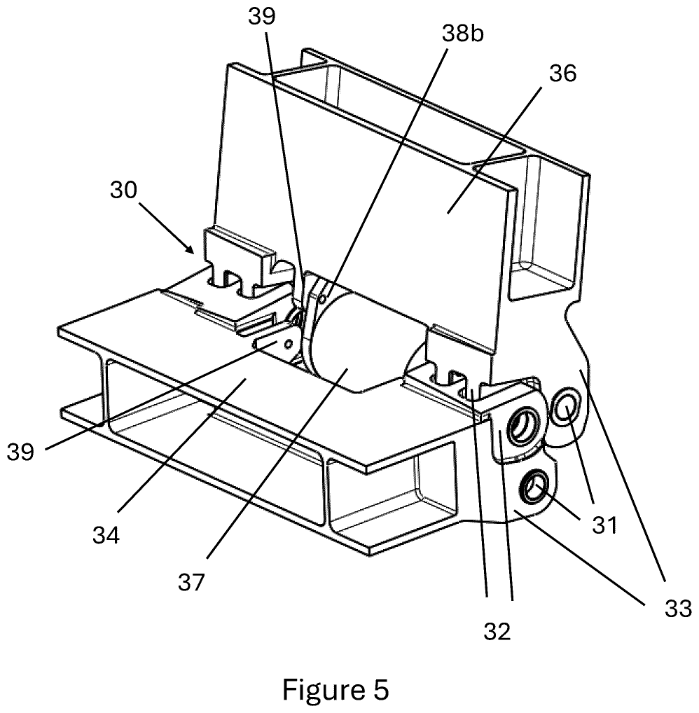

As shown in FIGS. 3 to 6, the hinge 30 is configured to be lockable when in the flight configuration. The hinge comprises further interlacing protrusions 33, by means of lugs integrally formed with the primary structure of the fixed wing 34 and the outboard wing section 36. The further interlacing protrusions 33 are offset from the hinge axis. The offset protrusions 33 comprise holes 31 wherein the center points of the holes 31 share a common axis when the aircraft wing 10 is in the flight configuration. Locking pins (not shown) are fed into the holes 31 to lock the rotation of the outboard wing section 14 into the flight configuration. Movement of the locking pins into and/or out of the holes 31 is effected by an actuations system (not shown) to selectively lock or unlock the folding wing in its flight configuration. When in the ground configuration (see FIG. 5 for example) the protrusions 33 are positioned such that the holes 31 no longer share a common axis. The actuator and hinge are arranged to withstand the loads necessary to hold the outboard wing section 36 in its ground configuration without the need for a separate locking system. It will however be noted that the high loads sustained by the wing, and transmitted from the wing tip to the wing root, via the interface between the fixed wing 34 and outboard (folding wing tip) wing section 36, can pass via the hinge lugs 32, and 33 and pins/locking pins, thus shielding the actuator from such high loads, in flight. Other means can be used to protect the actuator from being exposed to such in-flight loading, such as using a clutch arrangement, or latching mechanisms.

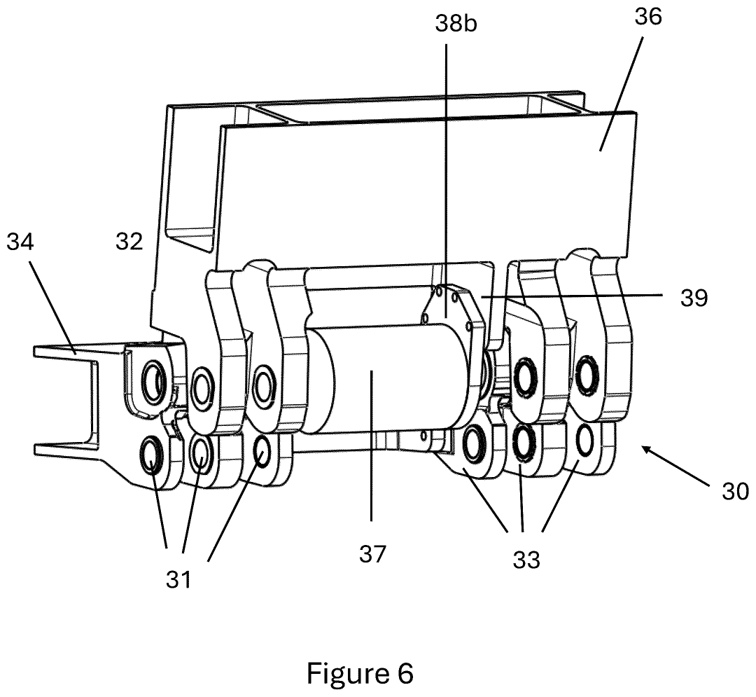

FIG. 5 shows the aircraft portion shown in FIG. 3 whilst in a ground configuration. The offset protrusions 33 and their corresponding holes 31 are shown to be separated such that the holes 31 do not share a common axis. FIG. 6 shows the aircraft portion in the same position as shown in FIG. 5 but from a different view so that the locking portion of the hinge 30 is more clearly shown.

The embodiment of FIGS. 1 to 6 thus provides a hinge mechanism having lugs that are mounted on hinge pins for providing the folding motion of the wing tip device, the lugs being integrally formed with primary structure of the fixed wing and of the folding wing tip section, wherein the folding movement is effected by a concentrically mounted rotary actuator that has a casing (or other part of the actuator) directly attached to a further lug integrated with the primary structure of the fixed wing and an arm directly attached to a further lug integrated with the primary structure of the outboard wing section. This provides many potential advantages, in terms of space and weight saving, because the alternative—where actuator attachments having bulky intermediate fittings and brackets attached to primary structure-take up more space, increase part count and potentially increase mass. This solution also facilitates actuation efficiencies including sympathetic loading and/or reduced loads on the actuator housing.

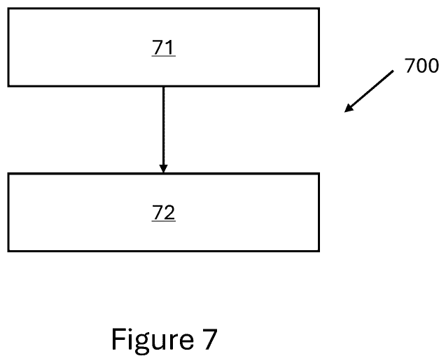

FIG. 7 shows a method 700 of moving the folding wing tip as shown FIGS. 1 to 6 from a ground configuration to a flight configuration. The method comprises a first step 71 of directly driving, using the actuator, the rotation of the folding wingtip via the lug integrally formed as part of one of the primary structures of the wing. The actuator moves the outboard wing section until the wing is at its fully extended length and thus in its flight configuration. The second step 72 comprises, once the outboard wing section is fully extended to the flight configuration, locking the hinge of the folding wing such that, in flight, loads are primarily transferred by the primary structures of the wing. The steps may be reversed. In other words, there may be a step of unlocking the folding wing, once the aircraft is on the ground, and then using the actuator to directly drive the rotation of the folding wingtip to its ground configuration, having a reduced wing span.

It will be appreciated by those of ordinary skill in the art that the method provided may be performed in a reverse order to move the folding wing tip from a flight configuration to a ground configuration.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The angle of the outboard wing section 14 relative to the fixed wing 12 may be different from that shown in FIG. 1 in other embodiments. For example the angle of the outboard wing section 14 relative to the horizontal (horizontal being 0 degrees) may be closer to 60 degrees from the horizontal or may rotate past 90 degrees (vertical) when folded up in the ground configuration.

In the Figures, the arm 38a forming part of the actuator casing is attached to the fixed wing and the actuator arm 38b is attached to the outboard wing section. In other embodiments, the actuator casing is attached to the outboard wing section and the actuator arm is attached to the fixed wing.

According to one embodiment of the present invention, the actuator is a multi-slice actuator (e.g. a multi-slice geared rotary actuator).

According to another embodiment of the present invention, an aircraft wing comprises multiple lugs, each integrally formed as part of the primary structure of the fixed wing or outboard wing section. Each lug is connected to an arm of the actuator, such that the actuator may directly move the outboard wing section between the flight and ground configurations.

According to yet another embodiment of the present invention, each arm of the actuator is connected to two separate integrally formed lugs, one on each opposing side of the arm.

The actuator arm of the actuator may be positioned at any suitable position along the length of the chord of the wing. The direct drive lug may be positioned anywhere along the chord to provide the most sympathetic mount for the actuator.

The actuator may have a casing that is directly attached to one lug (e.g., on the fixed wing section), with the rotating arm of the actuator being directly attached to an opposing lug (e.g., on the outboard wing section).

The images provided show the lugs biased toward one of the hinge lugs. A mid chord mounting is also possible.

The hinge may be configured to be lockable when in the ground configuration, for example using the same locking pins as used to lock the outboard wing section in the flight configuration (or the same holes with different pins, or with a different latching/locking arrangement). Locking or latching arrangements may be provided as part of the hinge or separately from the hinge.

The skilled person will appreciate that various different actuators and actuation methods may be used.

The feature of the actuator being shielded from flight loads may be implemented in other ways, for example via careful design of the actuator internals, including the use of backlash. In this context, backlash may be defined as a clearance or lost motion in a mechanism caused by gaps between the parts.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft wing comprising:
a fixed wing and an outboard wing section at a tip thereof, wherein the fixed wing comprises a primary structure and the outboard wing section comprises a primary structure, wherein the aircraft wing is configurable between a flight configuration for use during flight and a ground configuration for use during ground-based operations, wherein in the ground configuration the outboard wing section is rotated away from the flight configuration about a hinge axis of a hinge arrangement such that a span of the aircraft wing is reduced;
at least one lug integrally formed as part of one of the primary structure of the fixed wing and the primary structure of the outboard wing section; and
an actuator configured to directly act on the at least one lug to move the aircraft wing between the flight configuration and the ground configuration.

2. The aircraft wing according to claim 1, wherein the actuator comprises a rotary actuator.

3. The aircraft wing according to claim 2, wherein an axis of rotation of the actuator is parallel to the hinge axis of the hinge arrangement.

4. The aircraft wing according to claim 3, wherein the axis of rotation of the actuator is concentric to the hinge axis of the hinge arrangement.

5. The aircraft wing according to claim 2, wherein the actuator comprises a multi-slice rotary geared actuator.

6. The aircraft wing according to claim 1, wherein the hinge arrangement comprises one or more pins each having a longitudinal axis parallel to the hinge axis and each of which directly links the primary structure of the fixed wing and the primary structure of the outboard wing section to facilitate rotational movement of the outboard wing section about the hinge axis.

7. The aircraft wing according to claim 1, wherein the hinge arrangement comprises a locking hinge arrangement.

8. The aircraft wing according to claim 7, wherein the locking hinge arrangement is configured such that the actuator is protected from flight loads sustained by the aircraft wing.

9. The aircraft wing according to claim 7, wherein the locking hinge arrangement comprises one or more locking pins each having a longitudinal axis parallel to the hinge axis and each of which are configured to facilitate selective locking of the hinge arrangement, thus preventing rotational movement of the outboard wing section about the hinge axis.

10. The aircraft wing according to claim 1, wherein the hinge axis extends in a line of flight direction.

11. The aircraft wing according to claim 1, wherein the hinge arrangement comprises at least one further lug integrally formed as part of the primary structure of the fixed wing and at least one further lug integrally formed as part the primary structure of the outboard wing section.

12. The aircraft wing according to claim 1, further comprising:
at least two integrally formed lugs each of which integrally formed as part of the fixed wing or each integrally formed as part of the outboard wing section.

13. The aircraft wing according to claim 12, wherein at least one arm of the actuator is attached to the at least two separate integrally formed lugs to provide a lug positioned to abut each of two opposing faces of the at least one arm of the actuator.

14. The aircraft wing according to claim 1, wherein the span of the aircraft wing is at least 4 meters shorter in the ground configuration than in the flight configuration.

15. A method of operating a folding wingtip of an aircraft wing of an aircraft comprising:
directly driving, using an actuator, a rotation of a folding wingtip, relative to a rest of the wing, via a lug integrally formed as part of a primary structure of the aircraft wing;
locking the folding wingtip in a flight configuration such that, in flight, loads are primarily transferred from the folding wingtip into the rest of the aircraft wing by the primary structure of the aircraft wing; and
unlocking the folding wingtip, such that the actuator is configured to rotate the folding wingtip.

16. The method of claim 15, wherein the locking of the folding wingtip is performed such that the aircraft wing remains in the flight configuration for an entire flight,
wherein the unlocking of the folding wingtip is performed only when the aircraft is on the ground, and
wherein directly driving the rotation of the folding wingtip with the actuator occurs, after the unlocking of the folding wingtip, to a ground configuration, having a reduced wing span.

17. An aircraft comprising:
the aircraft wing of claim 1.

18. An aircraft wing comprising:
a folding wing tip configured for folding movement about a hinge axis,
wherein the hinge axis is defined by a hinge having a first portion integrally formed with a primary structure of an inboard part of the aircraft wing and a second portion integrally formed with a primary structure of an outboard wing tip, the first portion and the second portion mounted for rotation relative to each other with a pin that passes through one or more holes of each of the first portion and the second portion,
wherein one of the first portion and the second portion comprises a first integrally formed mounting fixture and the other of the first portion and the second portion comprises a second integrally formed mounting fixture; and
an actuator for moving the folding wing tip about the hinge axis, the actuator having a first part which is directly attached to the first integrally formed mounting fixture, and the actuator having a rotating output formed by a second part of the actuator which is directly attached to the second integrally formed mounting fixture.

19. A kit of parts for forming the aircraft wing according to claim 1, comprising:
at least part of the primary structure of the aircraft wing, for forming at least part of one of the fixed wing and the outboard wing section; and
the actuator, wherein the actuator is configured to directly attach to the at least one lug.
